(19) United States
(12) Patent Application Publication
(10) Pub. No.: US 2014/0002358 A1
(43) Pub. Date: Jan. 2, 2014

(54) COMPACT CAPACITIVE TRACK PAD

(71) Applicant: Frederick Johannes Bruwer, Paarl (ZA)

(72) Inventor: Frederick Johannes Bruwer, Paarl (ZA)

(21) Appl. No.: 13/996,901

(22) PCT Filed: Dec. 22, 2011
(86) PCT No.: PCT/ZA2011/000098

§ 371 Date: Sep. 16, 2013

(30) Foreign Application Priority Data
Dec. 23, 2010 (ZA) 2010/09238
Nov. 28, 2011 (ZA) 2011/08711

(51) Int. Cl. G06F 3/0354

(52) U.S. Cl. CPC G06F 3/03547
USPC 345/158

(57) ABSTRACT

A sensing system with four projected capacitance sensing electrode pairs which allows navigation of a two dimensional space associated with a mobile terminal. Buttons within the space can be selected by mechanical switches that provide haptic feedback. Operation of the switches is detected capacitively or directly. The capacitive coupling between a touch surface and the electrodes is improved by the use of suitable material. Force-dependent navigational or selection input of a user can be detected. Capacitive sensing track pad structures are integrated into traditional tactile keyboards or keypads.

### BACKGROUND OF THE INVENTION

The content of PCT/ZA2011/000021 is hereby fully incorporated into the present disclosure, without concession.

The invention pertains to user input devices for electronic products, particularly to detection of 2D movement and selection inputs on portable terminals using capacitive sensing.

Presently, compact mobile electronic terminals are taking up an increasing number of functions previously relegated to larger or fixed terminals. It is not uncommon for a human today to use his or her mobile phone to purchase products, browse the internet, communicate, photograph, document, navigate, study etc. This plethora of usable functions has significantly increased the need for compact user input devices that allow effortless navigation and manipulation of objects in the 2D space presented by the mobile terminal display. Two solution types have evolved to address this need. The first is a transparent touchscreen overlaid onto the mobile terminal display, allowing direct navigation and manipulation of the 2D space. However, this solution is costly, and suffers from other drawbacks, such as limited lifetime and forcing users to touch their screens which could lead to unwanted dirt and skin-oil deposits. The second solution type is a compact button-like device, allowing indirect navigation and manipulation. The present state of the art provides these in either optical or mechanical form, as will be discussed below.

As predecessors of present day mobile terminals, laptop and desktop computers used a large variety of user input devices. These included large pressure sensitive tablets with styli, mechanical mice, with a rollerball breaking light beams in the X and Y directions to capture user movement, optical mice which used irregularities in the supporting surface to deflect light in a varying manner according to the user's hand movement, small rollerballs inserted into the keyboard and capacitive touch pads. The latter are still used extensively in laptop computers, and are related to the present invention in some aspects.

In U.S. Pat. Nos. 5,495,077; 5,841,978; 6,188,391; 6,239,389; 7,202,859; 7,532,205; 7,656,392 and 7,821,502 assigned to Synaptics, U.S. Pat. No. 7,821,502 to Atmel and filing 2006/0066/581 by Apple, capacitive track pads are taught that utilize a matrix of orthogonal drive and sense lines or pads, in a 2D pattern. Further, in U.S. Pat. Nos. 7,129,935; 7,218,124; 7,548,073 and 7,692,431, all assigned to Synaptics, capacitive touchpads that utilize a high number of adjacent sense lines are taught. These two types of touchpad typify those found in today's laptop computers. User finger movement is detected by noting sequential capacitance changes, either from crossing to crossing, or along adjacent lines, or pairs of lines, and is unconstrained within the 2D borders of the touchpad. Due to the high number of lines, and associated 10's, as well as parasitic coupling, the method is not applicable to track pads on the order of 10 mm by 10 mm, as required by mobile terminals. It would require very high precision PCB manufacture, at a high cost. In US filing 2006/0244722A1 by Motorola, on a compact optical pointing apparatus and method, it is stated in paragraph [0009], that capacitive track pads need to be several times the width of the user's finger to be effective, and that this drawback has kept them out of handheld terminals at that stage of the art. Further, due to the matrices of orthogonal lines, capacitive touchpads of this type are constrained to rectangular shapes.

In US filing 2009/027573 by Apple, a mutual capacitance touch sensing device that is based on multiple groups of nodes is taught. A node is defined as 2 or more drive electrodes, and 2 or more sense electrodes. User finger movement is detected when capacitance change occurs sequentially from group to group. Therefore, movement detection is constrained by the pattern in which the groups of nodes, or electrodes, have been placed. Unlike the above Synaptics touchpads, a large number of shapes and patterns can be realized, without the rectangular constraint.

With the fast evolution of mobile electronic terminals, a fair amount of mechanical navigation and selection buttons have been contrived. Although these can be low cost, they somewhat constrain user navigation, with some types only allowing movement in the X or Y axis. For webpage browsing, this is not practical. Further, the contacts and mechanical mechanism of the buttons suffer wear and tear, limiting operational life. And protection against environmental ingress is challenging, requiring flexible coverings, which increases cost.

To overcome the ingress problem of mechanical solutions, and provide more unconstrained user navigation and selection, optical track pads have been developed. Crucialtec teaches such compact optical track pads (OTP's) in US filings 2008/0218474 A1 and 2008/0218769 A1. In essence, these devices operate much like extremely compact inverted optical mice. Infrared light is projected via a lens onto the user's finger. Due to skin irregularities, it is reflected back onto a sensor in a particular pattern. If the user finger moves, the pattern detected by the sensor changes. If sequential pattern changes are processed, the movement direction can be discerned. User selection inputs are still detected via mechanical switches in present state of the art modules. Although these devices have been widely deployed in present state of the art mobile phones, they suffer from a number of drawbacks. Considering mobile phone battery life, typical current consumption is high, in the mA range. They are susceptible to infra-red emissions from remote controls, particularly unintended scrolling of a webpage. Some reports of interference caused by sunlight or strong lighting have surfaced. Due to the sensitivity required, extremely high precision optical manufacturing is required, leading to high cost per unit, in some instances more than 3% of the complete bill of materials for the mobile phone. Only dedicated plastic coverings can be used on the track pad, due to the need for infrared permeability, and filtering, with high susceptibility to deep scratches limiting use in rugged applications. The OTP is also sensitive to the color of the user's skin, and its texture. It is also fairly difficult with present state of the art OTP's to detect rolling movements of the user's finger, as opposed to normal swiping movements. Lastly, by using a mechanical switch for selection detection, the problems of ingress and mechanical wear and tear persist.

In a number of prior art 2D navigation sensors a conductive surface spanning the area of sensing is required. Above a screen, such as an LCD, this is typically transparent (e.g. ITO coated glass or PET) which is costly to manufacture. The invention to be disclosed hereafter typically does not require any transparent conductive surface.

The invention presented herein purports to overcome the drawbacks of the above technologies, and is specifically aimed at improving the state of the art of user input devices allowing 2D navigation in mobile and other electronic terminals.

### SUMMARY OF THE INVENTION

An extremely compact user input device which could allow unconstrained two dimensional (2D) navigation and selection, with dimensions on the order of 2 cm by 2 cm or less, typically the width of a user's finger, and based on highly sensitive capacitive sensing technology, with a minimal number of drive and sense lines and electrodes, is disclosed. Electrodes, in the sense of the disclosed invention, refer to conductive structures that may be used for capacitive sensing, or to make or break connections in an electronic circuit or circuits. An electrode sense pair for projected (or mutual) capacitive measurements is formed by a driver or transmitting electrode or sense plate and a receiver or sensing electrode forming a capacitive coupling that is measured. Specifically, the invention is aimed at mobile electronic terminals such as mobile phones, remote controls, for instance for web based television sets, e-Readers, for example a Kindle™, and gaming consoles, although it must be understood that it is by no means limited to these applications only.

In one embodiment of the invention, it may consist of only four electrode pairs and a projected (mutual) capacitance sensor and controller, with specific firmware being executed. The four pairs may be formed by two electrodes configured as drive electrodes, and two as sense (or receiver) electrodes. Or the electrodes may be constructed in a way to measure all four (or other number) at the same time. The electrodes are typically arranged in an optimum pattern. By alternately sensing the capacitance change between the various combinations of drive and sense electrodes, user finger movement may be detected with very high resolution and stability. The driving and sensing electrodes may be of various configurations or structures such as shown in the drawings. Specifically they may be on a single side of a PCB or on a single side of glass or other transparent material. In the latter cases the electrodes may consist of ITO or a range of other electrically conductive materials. The driving and sensing electrodes may also be dual-sided in construction such as on the two sides of a PCB. Finally the electrodes may be multi-sided such as on the side(s) of a PCB structure and also through the PCB (or material) such as using, for example, the construction of a through hole via to form an electrode. In this embodiment, the method of using a tap or double tap gesture to indicate a selection may be employed, if the touch start and release actions are cleanly handled in the Compact Capacitive Track Pad (CCTP) module. The tap gestures are bound to be well accepted by the market due to user experience on notebook and lap top PC track pads, and should hold several advantages in terms of cost and construction when compared to integrating a tactile or dome switch structure in the CCTP module. This aspect of the invention possibly allows it to overcome the ingress and mechanical wear problems inherent to all other present state of the art mobile phone user input devices, as the CCTP may be completely sealed within the mobile terminal plastics, and might be without any moving parts.

Thus, in one form of the invention, there is provided a capacitive 2D track pad wherein only four projected capacitive sensing electrode pairs are used to determine any parameter from the group comprising speed, direction and distance, of a user touch gesture on a 2D plane, and that allows indirect user navigation in a displayed 2D space on a display terminal.

In a variation of the invention, the above embodiment could be augmented by an inexpensive dome switch or similar structure, underneath the CCTP overlay. However, the dome switch may not only be used to physically make/break an electrical connection, but is rather used in a capacitance measurement configuration to detect the deflection when pressure is exerted on the dome switch or other structure (on top or below) that deflects under pressure. The CCTP may contain an electrode or a plurality of electrodes that are used for capacitance measurement, to detect proximity of the user's finger, or other relevant body parts or members in general. If the CCTP is depressed against for e.g. the dome switch, a capacitance measurement could be used for detection hereof. For example the drive electrode may be contained in the PCB, and the metal of the deflecting structure may be used as the receiver electrode. Once depressed, the distance and capacitance between sense and drive electrodes are altered measurably, and the action is detected. In a variation, the metallic or conductive structure's deflection results in a variation in the capacitive coupling between a pair of projected sensing electrodes on a PCB—(one transmitting and one receiver electrode), in that a metal object is approaching both and this may enable the recognition of a pressure event. Surface capacitance implementation variations on this theme are also possible.

In a variation of the above embodiment of the CCTP invention, the dome switch may be used to break an electrical connection to note user selection, as is typically done with Optical Track Pads (see for example Nokia E72 mobile phone or several circa 2010 Blackberry phones). Therefore capacitance measurements may be used to detect proximity and user navigation with electrodes and firmware as per the first embodiment. To select, the user may depress the CCTP, resulting in electrical contact by the dome switch that may be detected.

In yet another possible embodiment of the invention, the disclosed CUP with dome switch incorporated may be used to detect user body proximity, user navigation, and offer two levels of selection. The electrodes described by the above embodiments may be used to detect user proximity. Once detected, this may be used for example to turn the backlight of an LCD on, or wake the mobile terminal from a power saving state. Here-after, the electrodes and specific firmware described by the above embodiments may be used to measure user navigation of the displayed 2D space, for example a webpage. To enable user selection, two mechanisms may possibly be provided by the CCTP. The first may be a light tap or double tap (touch) of specific nature, but without sufficient pressure to depress the dome switch or similar structure. Capacitive measurements may be used to detect this selection type. The second selection type may be a touch with sufficient pressure to depress the dome switch or other structure that will facilitate a tactile feeling. This selection type may be detected either galvanically, or capacitively, as described above. For example, a user might want to use the first selection mechanism to select a large number of icons within a displayed 2D space. Once all icons are selected, a single harder press on the CCTP could activate the second selection mechanism, resulting in a similar action being applied to all selected icons. This is similar to using a desktop or laptop computer mouse and the CTRL key simultaneously to select multiple icons and then applying one action, with the comfortable difference that only one input device is used at a given time.

In all the above embodiments, a similar increase or decrease in capacitance between all electrodes simultaneously may provide a boundary condition indication that the user is entering, or is about to enter, a selection. During navigation, the user finger moves between electrodes. This typically results in a dissimilar capacitance increase/decrease for the various electrode pairs and combinations. However, if the user is pressing down, or starts to press down, capacitance will typically increase or decrease at a single sensor or group of sensors. This may alert the controller to monitor the following data for a possible selection event, be it via a capacitive or mechanical dome switch. Typically, the above technique requires highly sensitive capacitance measurements, and may be implemented via projected (or mutual) capacitive, or surface capacitive measurement technology. However, this invention is not limited to this technology, and may be applied via any capacitance measurement technique that provides sufficient sensitivity.

The total capacitance measured across all the sensors may also be used as part of the equation to determine relative movement. For example an equal increase in counts across all measurements channels may indicate a stronger touch. A change in touch strength above a certain level (up or down) may be used to inhibit movement detection to reflect beginning and ending of a user gesture.

The disclosed CCTP device may also be used to detect rolling movement of the user's finger, in addition to the normal sliding movement. This will be especially convenient since the user does not need to lift his or her finger off the CCTP surface to register movement. It is important that the user may move the cursor over the full screen through a rolling action and manipulate the cursor position very effectively without lifting his or her finger.

The position of touch as described here is determined through the interpolation of the data as measured between the various electrodes. Typically two electrodes are used for X-direction and two electrodes are used for Y-direction. This relative measurement may create a problem at the boundaries, where it may not be clear that the user's finger has crossed outside the group of electrodes and this may lead to ambiguities in interpreting the data measured. However, it may be possible to create a boundary around the CCTP to remove this uncertainty. This is be done by positioning another sensing electrode structure within close proximity of the existing outer electrodes. This unequally spaced electrode may be shared, i.e. the same channel may be used on more than one side. Furthermore, it may be possible to only pair a single sense electrode, or a single drive electrode with the complementary electrode on the boundary. This will allow the edge of the CCTP to be more accurately detected by monitoring the relative change in measurements of the inner and outer channels per side. The second sensor channel need only be used for boundary determination.

Unlike other state of the art technologies, the invention may provide an extremely compact track pad. For example, it may be possible to realize a CCTP with dimensions between 8 mm by 8 mm to 2 cm by 2 cm, with just four electrodes. Due to capacitive sensing technology used, the disclosed invention may have extremely low power consumption and very low cost. For example, it is common to have CCTP supply currents in the low μA range.

Given the typical materials used by and dimensions of the disclosed invention, manufacturing may be much simpler, with the potential for fairly wide manufacturing tolerance margins. Therefore the disclosed invention might be very cost effective.

Another advantage of the disclosed invention is that it provides a mobile terminal track pad which may be more reliable, as there are few parts, and in some embodiments none, moving, unlike solely mechanical user input devices. It may also be suitable for use in rugged environments, as deep scratches on the track pad covering should not affect it significantly. Further, it may provide a mobile terminal track pad which is unaffected by infrared remotes. It may also be possible, through application of the disclosed invention, to realize a track pad that may work with a large number of inexpensive plastics, of varying thicknesses. Another aspect of the invention is the possibility for scaling. For example, the CCTP may be increased in dimensions by up to a factor of 2, with only a requirement for new firmware.

The disclosed invention also has fair field adjustability, and user selectable sensitivity range, based on proprietary firmware used in the CCTP.

Varying colors or shapes for the cursor, which relays relative position in the displayed 2D space, may be used to indicate various sensing conditions such as specifically—no touch/proximity; proximity detected; touch detected; touch movement detected and hard touch detected (without movement).

The disclosures above may actually enable the measurement or determination of absolute positions as well, offering the advantage of immediate positioning of a cursor or selection.

A further embodiment of the present invention may allow the realization of a low cost joystick that may sense the amount of force a user exerts in a particular direction. If a dielectric or conductive plate is placed above the various electrode pairs of the disclosed CCTP, and is supported mechanically by a flexible member, for example a spring, or compressible/flexible material, and the movement of the joystick tilts said plate to a particular direction, the capacitance of the electrodes should vary measurably according to the tilting angle of said plate. Since a certain amount of force is required to bend or compress the flexible member such that the plate arrives at a specific position, it may be possible to sense not only motion to a specific side, but also the amount of force exerted by the user in that direction.

A further embodiment of the present invention is the realization of a CCTP which may not only allow efficient navigation of a displayed 2D space, but also force dependent 2D navigation. This may assist to overcome the challenge of sensing navigation inputs if the user's finger covers all electrode pairs in an equal manner. By inserting a CCTP module, as taught during the previous discourse, into a section of compressible/flexible material, and realizing additional electrode pairs, which are static in position, on the periphery of the compressible/flexible material, and having conductive strips on the sides of the CCTP module, in juxtaposition to the additional electrode pairs, the force by which the user presses the CCTP module to a given side may be sensed, similar to the manner of the above mentioned joystick. This information may be used to affect the distance and speed of a cursor associated with the track pad on for example a pc or mobile phone display, or in a remote control and TV pair for example. This may have particular application in web enabled TV, or with products such as the Google™ TV type products. As said conductive strip approaches a given electrode pair, the amount of charge sensed changes, resulting in a change in charge transfer counts and capacitance measured. To position the CCTP module at a particular point, a specific amount of force will typically need to be exerted. This may allow determination of the force by which the user is trying to navigate. A higher force level may indicate user agitation, urgency, or other conditions, which may be used to adjust sensitivity, speed with which the cursor moves and other parameters. The construction may also be such that only said conductive strips are positioned on the floating member and the electrode sense pairs are all positioned on the outer member that forms the well that holds said floating member. This will alleviate any connection problems with regards to power and data lines to the floating/moving member. This configuration may further include the downward pressure switching functionality. As such pressure on both horizontal planes (2D) and in a vertical direction (dome structures) can be detected, as well as the tracking and proximity functions.

In another embodiment the disclosed track pad functionality may be combined with a number of tactile type switch functions in a structure such as is typically found on a remote control device for TV's and television decoders with five buttons (north, east, south and west, with OK in the center). The overlay structure (typically a circular ring with a round button in the center, with inscriptions indicating button function) may be placed upon a compressible/flexible layer. This layer will act as a better dielectric than air but still allow the user to effect a “click” effect on the five switches when pressure is exerted at the right position. The switches may function as capacitive switches (as described herein) or conventional switches where electrical contact must be made/broken to indicate switch actions. Said buttons may be located above the electrode pairs of the track pad, or may be located above dedicated additional electrode structures. Such an embodiment may find good application in remote controllers for television sets that have internet browsing abilities, as the increasing number of user actions typically required for such applications are not easily satisfied by the traditional mechanical five button structures, seeing that these only allow fairly constrained navigation of presented 2D spaces.

A benefit that arises from the capability to detect and measure pressure on the floating member of the CCTP in a specific direction is to have dual tracking detection modes. In cases where the user inadvertently covers the full track pad with a finger (typically due to too much pressure) the pressure measurements may provide enough information for the track pad to function seemingly normal.

Thus, according to another aspect of the invention there is provided a capacitive measurement track pad system using surface and/or projected capacitive measurement methods implemented in a single integrated circuit to recognize proximity detection or touch detection events in multiple electrodes or electrode pairs, as well as events related to touch events where more than a predetermined minimum pressure is applied to a structure causing a snap effect, through the capacitive measurement of the structure in the snapped state, wherein the snap can be detected by the user and wherein the capacitive sensing system further offers track pad operation and functionality using the capacitive measurement information from multiple electrodes or multiple electrode pairs related to the movement of the location of the detected event.

Yet another exemplary embodiment of the present invention allows for the integration of a 2D track pad and tactile button key pad or key board, as disclosed by the following. Said track pad employs a number of orthogonal electrodes on a single layer, with bridging connections on a second layer, and uses projected capacitance measurements to track the movement of an engaging probe, which may be a user's finger. For example, the electrodes may be in the form of a number of series connected diamond shapes, with thin, short sections, relative to the diamond shapes, connecting the various diamonds of a specific electrode together. Further, according to the present embodiment, by using a dome switch-like structure to place floating conductive material, said conductive material being either the dome itself, or material attached to the underside of its apex, over the junction of a plurality of said diamonds, a capacitive sensing tactile switch similar to that disclosed by PCT/ZA2011/000021, held by the present inventor, may be realized. If the user depress the dome switch structure beyond a certain point, it will snap or click and the measured mutual capacitance for said junction will typically change abruptly. This characteristic may be used to discern a user switching action that required more than a predetermined minimum pressure. The conductive or non-conductive nature of the dome material may result in either a decrease or an increase in capacitance measured at a electrode pair.

By using a plurality of dome switch-like structures in the above disclosed embodiment, placed over a plurality of electrode junctions, a 2D track pad may be integrated into traditional key pads and key boards, for example T9™ or QWERTY™ types, according to the present invention. The biggest advantage of such an embodiment of the present invention may be that it still offers the user tactile feedback when individual buttons are depressed, but also allows for an realization of a 2D track pad using the upper surface of what was heretofore only considered for use as a key pad or key board. Another advantage may be that the physical mechanism of the buttons is capacitive in nature, implying the same controller may be used for the detection of 2D navigation and button activations of the user. As there are no electrical connections made/broken it is spark free and a good safety mechanism for use in gaseous environments.

In one form of the invention there is provided a 2D capacitive track pad that utilizes a plurality of sensing electrode pairs used for projected capacitance measurements, and with a plurality of conductive dome structures placed over specific junctions of said electrode pairs, where sufficient pressure on said overlay above the dome structures results in a snap or rapid deflection of the dome structures, providing the user with tactile feedback, and resulting in a sudden change in the capacitance measured for a specific electrode pair without making or breaking electrical contact, which can be used to discern a user selection action equivalent to a button activation.

A further exemplary embodiment of the present invention is the incorporation of touch tracking based predictive text entry held by the present art, and sold commercially, for example by Swype™, into an integrated 2D track pad and key board or key pad, as disclosed in the above discourse of the present invention. Such predictive text entry used in conjunction with the present invention may find good application in lower cost mobile electronic terminals, for instance cell phones, which at present only use low cost mechanical button key pads or key boards.

Naturally, an integrated 2D track pad and key pad/key board of the present invention, as disclosed above, is not constrained to the use of only diamond shapes for the realization of electrodes, but may use any other relevant geometric form.

Relevant to all the above mentioned embodiments is the fact that combinations of the listed embodiments, and new embodiments that fall within the sphere/claims of the disclosed invention, may be possible, and the above is by no means intended to limit the scope of the invention, but merely to assist in its disclosure.

### BRIEF DESCRIPTION OF THE DRAWINGS

The invention is further described by way of examples with reference to the accompanying drawings in which:

FIG. 1 shows an exemplary electrode pattern according to the embodiments described above;

FIG. 2 shows exemplary relative sizes in a perspective view of a user's thumb above a separating dielectric and the electrode pattern of the CCTP;

FIG. 3 shows an exemplary embodiment where a mechanical dome switch is placed underneath the CCTP;

FIG. 4 shows an exemplary mobile electronic terminal, and the location of the CCTP;

FIG. 5 shows the difference between a touched area for a concave, and for a convex, upper surface of the CCTP;

FIG. 6 shows a basic schematic diagram of an exemplary embodiment of the invention;

FIG. 7 shows a schematic diagram of an exemplary embodiment of the invention that includes a dome switch that makes a galvanic break to indicate user selection;

FIG. 8 shows a schematic diagram of an exemplary embodiment of the invention that utilizes a dome switch for projected capacitance measurement;

FIG. 9 shows an exemplary variation in measured capacitance for two separate projected channels due to a rolling action of a user's finger;

FIG. 10 shows an exemplary use of an additional guarding electrode to detect movement of a user's finger beyond compact boundaries of the CCTP, to improve resolution and functionality;

FIG. 11 shows an exemplary embodiment that utilizes electrodes on multiple layers, in this example stacked in a vertical direction;

FIG. 12 shows an exemplary embodiment where a single transmit electrode is placed in the center of the CCTP, with four receive electrodes on the periphery. This could be conversely applied as well;

FIG. 13 shows a top view of an exemplary embodiment that realizes a force dependent joystick based on a CCTP as disclosed by the present invention;

FIG. 14 shows a side view of two exemplary embodiments of the present invention in the form of force dependent joysticks that are based on a CCTP, also showing the perturbation of typical electric field patterns;

FIG. 15 shows an exemplary embodiment of the present invention that allows force dependent 2D navigation to be sensed;

FIG. 16 shows, in exemplary manner, an alternative embodiment to that of FIG. 15 that does not require any connections to a floating member from an electronic circuit in order to sense force dependent 2D navigation;

FIG. 17 shows another exemplary embodiment of the present invention where a five button structure, such as typically found on TV remotes, is realized over a compact capacitive track pad, with a compressible/flexible medium improving capacitive coupling; and

FIG. 18 shows yet another exemplary embodiment of the present invention that realizes a five button structure, with button action detected capacitively, over a two-dimensional navigation pad that utilizes an array of projected electrodes.

### DESCRIPTION OF PREFERRED EMBODIMENTS

The following description of various embodiments, according to the preceding graphical illustrations, is given in an effort to fully disclose the invention, to enable sufficient comprehension by persons skilled in the art of capacitive sensing. However, the scope of the disclosed invention should by no means be limited by said description, and it is possible that a range of other embodiments can be realized that still fall within the claims to be presented hereafter.

To accurately and reliably measure small movements of a user's finger or thumb over a track pad that is smaller than the finger or thumb requires ultra-sensitive measurement technology. However, given the ever decreasing cost of mobile electronic terminals, relative to their processing power and functionality, the required solution needs to be cost effective as well. Therefore, having a high number of electrodes, with inter electrodes distances that does not leave much margin for manufacturing tolerances, and therefore being costly, is not a good option. If one reduces the number of electrodes to negate this drawback, the amount of required sensitivity to still detect the change in capacitance with a high enough resolution to enable use in a 2D track pad becomes increasingly higher. The amount of processing power required also increases significantly, more so if the sensitivity is not high enough.

These factors have combined to withhold compact capacitive track pads from mobile electronic terminals up to the present.

According to the disclosed invention, it may be possible to realize a high resolution compact capacitive track pad that is sufficiently small and cost effective to allow use in mobile electronic terminals, which will greatly improve the art, and challenge status quos.

The invention is based on the fact that an absolute minimal number of electrodes are used within a sufficiently small area, and by their arrangement, the methods by which their mutual capacitance is monitored and processed, and the techniques applied to discern various user actions.

FIG. 1 shows an exemplary electrode pattern according to the invention. Electrodes 1.1-1.4 are the driving or transmit electrodes, with the electrodes 1.a-1.d the sense or receiver electrodes. Horizontal pairs are formed by electrodes 1.1 and 1.a, and electrodes 1.3 and 1.c. Electrodes 1.2 and 1.b, and electrodes 1.4 and 1.d form vertical pairs. The transmit electrodes 1.1-1.4 charge the capacitance between them and the receiver electrodes 1.a-1.d according to a certain frequency and waveform.

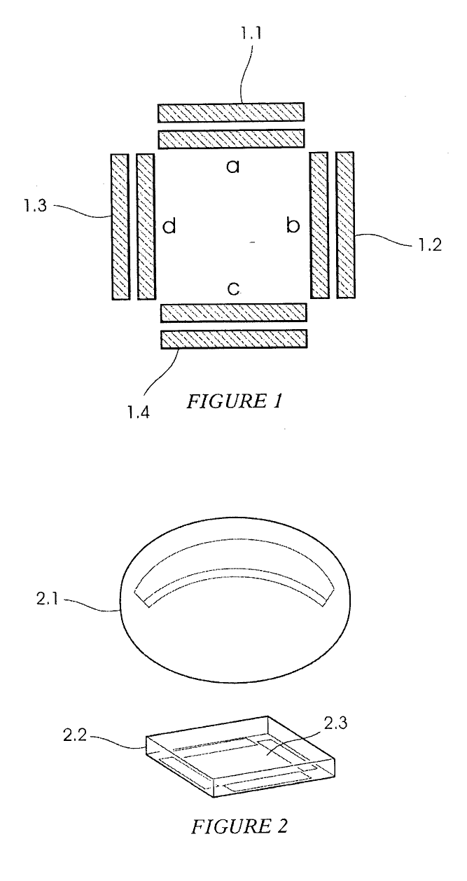

FIG. 2 shows an exemplary user's finger 2.1 above a CCTP module 2.3 with dielectric 2.2, and an electrode pattern similar to that of FIG. 1. If a user's finger 2.1 is in close proximity to the various pairs of electrodes, the fringing electric fields surrounding the electrodes are perturbed. This typically results in less capacitance between drive and sense electrodes when, for example, a projected capacitive measurement implementation is used. During approach of the user's finger towards the CCTP, the amount of capacitance should change for all electrode pairs simultaneously in the same direction. The proprietary firmware executed by the CCTP may sense this simultaneous change, and prepare for an imminent proximity or touch event. In the example of using projected capacitive measurements a drop in the capacitance measured for an electrode pair will result from a user's finger approaching or touching the CCTP. Once the capacitance for all electrode pairs falls below a proximity threshold, a proximity event may be declared by the CCTP module. This may be communicated to the hosting mobile electronic terminal, which may use it to wake up from a low power state, turn the backlight of an LCD on, etc. If the measured projected capacitance for all electrode pairs continues to fall until below a touch threshold, the CCTP may declare a touch by the user.

To detect 2D movement of the user's finger 2.1, the difference in projected capacitance change between the various electrode pairs is continuously monitored. For example, if the user's finger moves in a straight vertical line, the change in measured projected capacitance for the two pairs of vertical electrodes 1.2/1.b and 1.4/1.d should be minimal. However, the change in projected capacitance for the two horizontal pairs 1.1/1.a and 1.3/1.c should be quite large. As the user's finger approaches the bottom horizontal electrode pair of 1.3/1.c, the projected capacitance for this pair should decrease significantly, typically reaching a minimum if the user's finger contact point is directly over the pair. At the same time the opposite electrode pair will experience an inverse effect. Conversely, if the user's finger moves in a horizontal direction, the measured projected capacitance for horizontal electrode pairs 1.1/1.a and 1.311.c should stay fairly constant, but projected capacitance for the vertical pairs 1.2/1.b and 1.411.d should change significantly, with the direction of movement determining which pair ends with the lowest capacitance. As such, movement is always accompanied by an opposing change in measured capacitance at opposing electrode pairs.

By alternately (or simultaneously) monitoring the horizontal and vertical electrode pairs, according to the above characteristic change in projected capacitance, it is possible to detect user finger movement with a very high resolution, which may enable accurate navigation of the exemplary 2D space 4.2 displayed by an exemplary mobile electronic terminal 4.1 via a CCTP module 4.3 in FIG. 4

If the user wants to highlight/navigate to discrete icons in a 2D menu, a slightly different, simplified technique may be used. As before, a touch event may first be declared by the CCTP. A starting capacitance value for all electrode pairs is stored. Hereafter, the CCTP may discern between a vertical or horizontal movement through comparison of the capacitance delta for the two groups of electrodes. This may be followed by declaration of a specific direction, left, right, up or down based on the pair with the lowest capacitance value. The starting position or icon may be the previous ending position or icon, when last the 2D menu was accessed, or it may be based on an absolute position detection algorithm.

FIG. 6 illustrates an exemplary circuit diagram of a CCTP as implemented above. As is evident, it may allow for a minimalist approach to implementation of a compact track pad for mobile electronic terminals. An integrated circuit is used to perform the required capacitance measurement and controlling functions and typically supply highly accurate finger movement and user selection data to the hosting terminal via a simple digital data bus.

For example, this may be a two-wire type, using one of the industry de facto protocols such as I²C. Furthermore, all required filtering and digital signal processing of the raw capacitance data may be done within said integrated circuit or may be done on the host microcontroller when only raw data is supplied. With the typical dimensions of these integrated circuits well below that of disclosed CCTP modules, they may be completely integrated within the module.

Once an icon has been highlighted, the user may want to select it, to activate further functions or open a specific item. To this end, the disclosed invention may enable the use of a double tap gesture on the CCTP, using only capacitive sensing. For example, if the controller in the CCTP senses two touch events with projected capacitance values that differ by less than a specific maximum for all four electrode pairs, within a certain period, a double tap gesture is declared and communicated to the hosting mobile electronic terminal. A further criterion for the declaration of a tap/double tap event may be that no movement had to precede the first tap, or both taps (touches), for a certain minimum period of time.

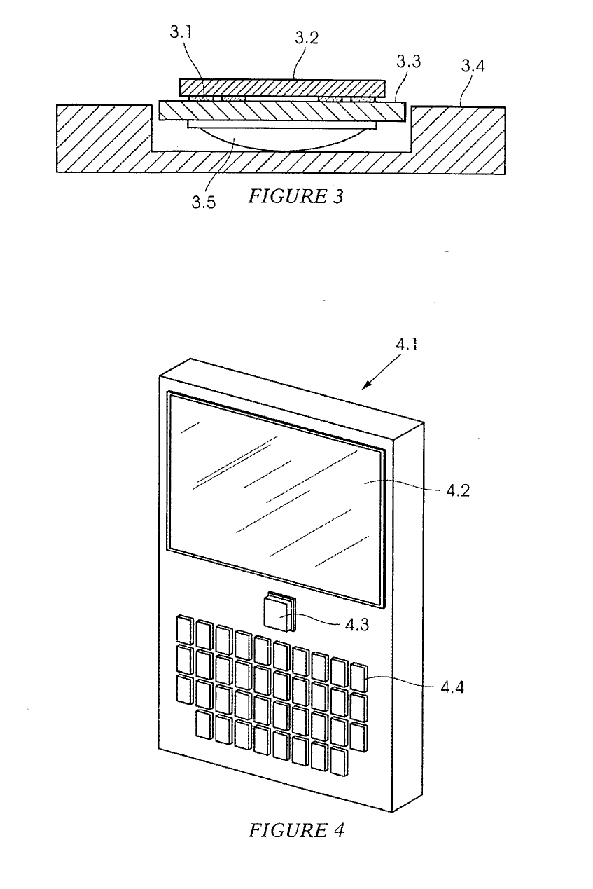

However, according to the disclosed invention, it may also be possible to enable user selection through use of an inexpensive dome switch. FIG. 3 illustrates an exemplary construction of such a CCTP. A dome switch 3.5 is for example mounted on the bottom of the CCTP, with a carrier 3.3 typically directly above it. Electrode pairs 3.1 are typically deposited onto the carrier 3.3, and are covered by a dielectric material 3.2. It should be noted that the carrier 3.3 may be a PCB consisting of FR4 or other material, or a module that includes the CCTP semiconductors and required substrates for electrode deposition. The whole assembly may typically be situated in a recess of a hosting mobile electronic terminal 3.4. Proximity, touch and navigation detection may be implemented in a similar manner as described above. Once the cursor is above a certain element in the displayed space, the user may depress the CCTP until the dome switch is activated to indicate selection. As stated previously, it is possible to use the activation of the dome switch 3.5 to either break an electric current, or change a capacitance measurement significantly, both being sufficiently measurable to detect the selection event. In another embodiment the sensing electrodes are deposited on the carrier 3.3, for example conductive material on glass material.

The above may also allow the use of a mixture of projected and surface measurements by the CCTP. The electrodes 3.1 may be deposited with dimensions that allows surface (or self) capacitance measurement. As the user finger approaches the CCTP, surface measurements are used to detect proximity. Once the finger touches the CCTP, a mixture of surface and projected capacitance measurements may be used to detect touches and user navigation. To select, the user may depress the CCTP to activate or snap the dome switch 3.5. In another embodiment the dome switch is connected as a receiver electrode for projected capacitance measurement. Once the dome switch 3.5 is depressed sufficiently to activate it (snap/click), a sudden increase in measured capacitance should result, as the distance between the transmitting electrode 3.1 and the receiver dome switch (as electrode) should decrease quite significantly over a short period. The same can be achieved with a surface capacitance measurement through the dome being grounded for example. The use of this method allows for a feel equivalent to that of a normal electromechanical switch, although no making or breaking of electrical contact is required. This offers advantages in terms of wear and tear in a electromechanical switch as well as robustness against dirt, debris, or humidity for example.

Thus the proximity and/or touch events are used to provide information to a user with regards to specific buttons in close proximity to the user's finger or operating member and/or touched by a user. Also, the touch event with at least a minimum pressure applied through the touch is used to recognize an event equivalent to an electromechanical button switch being pressed.

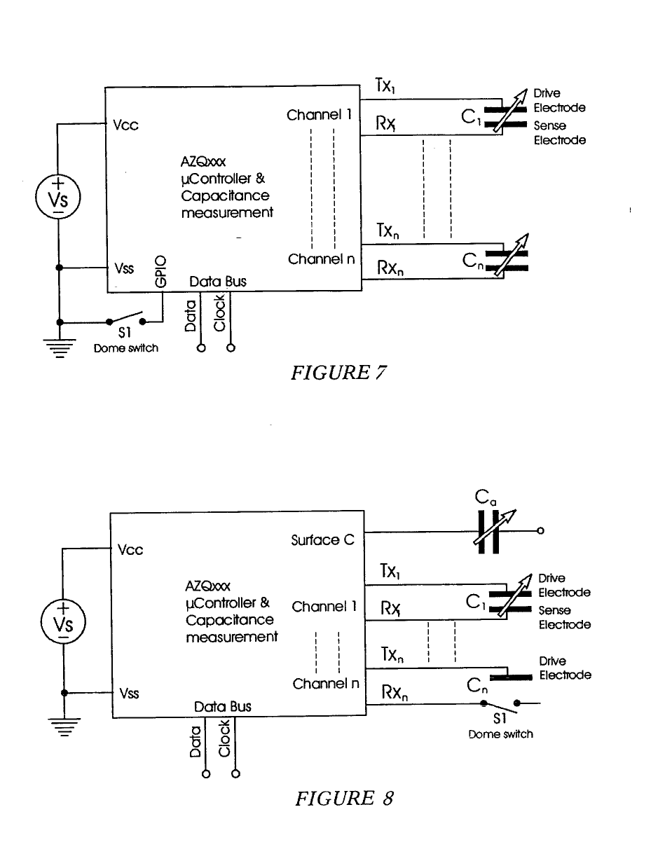

FIG. 7 and FIG. 8 illustrate exemplary circuit diagrams for CCTP's that include the use of inexpensive dome switches. In FIG. 7, an example is given where the dome switch is used to make or break a connection to system ground potential. FIG. 8 illustrates, as an example, the use of the dome switch on one of the projected capacitance measurement channels, as discussed above.

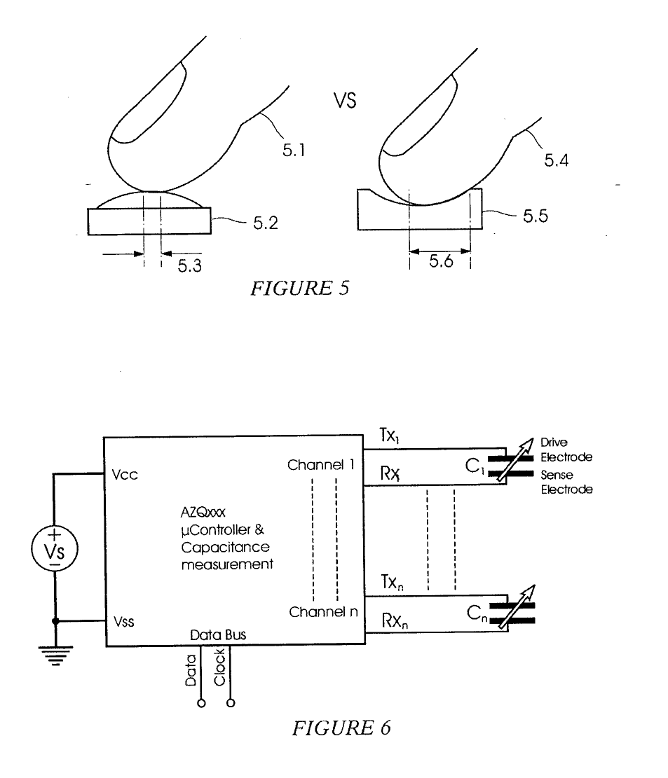

FIG. 5 shows another aspect of the invention. By rounding the upper surface of a dielectric 5.2, a user finger 5.1 touches the CCTP over a significantly smaller area 5.3. Conversely, if the upper surface of the insulating dielectric 5.5 of the CCTP has a flat or concave shape, the user touch area 5.6 should be much increased. This may make it more difficult to track user finger movement with high resolution.

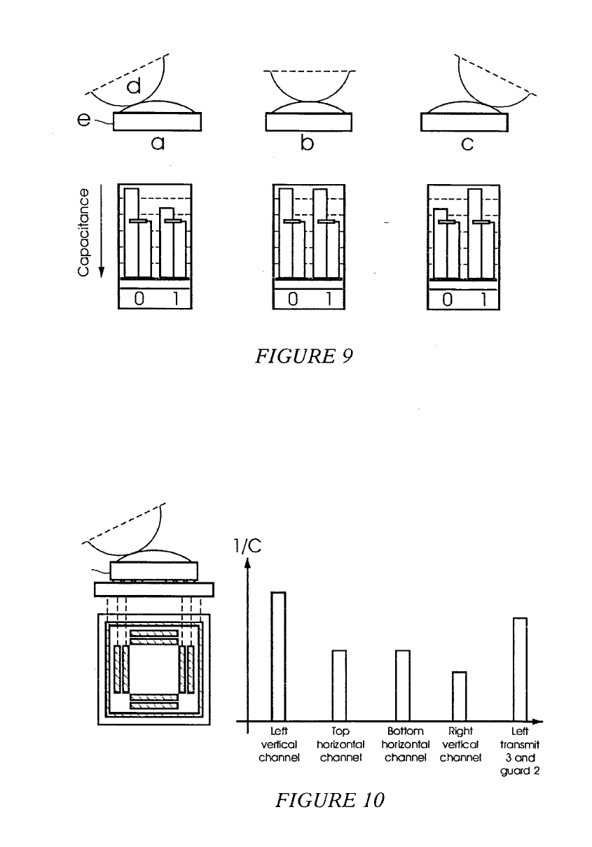

A significant contribution of the disclosed invention to the state of the art is the ability to use only rolling movement of the user's finger to enable 2D navigation. FIG. 9 illustrates, in an exemplary manner, the effect of a rolling action on measured projected capacitance. On the left hand side, in section 9.a, the user's finger 9d is rolled to the left of the CCTP top surface 9e. For argument's sake, let this be in a horizontal direction. Therefore, the measured capacitance for the two horizontal channels should be similar, as shown by 9.a.0 and 9.a.1. However, the measured capacitance for the left-hand vertical channel is significantly lower than that of the right-hand vertical channel. As the user rolls his or her finger to the middle of the CCTP module top surface, the measured capacitances for the left-hand and right-hand vertical channels should equalize, with the horizontal channels unchanged, as illustrated in an exemplary manner by channels 9.b.0 and 9.b.1. As the user finger rolls to the right of the CCTP module top surface, the measured capacitance for the right-hand vertical channel should decrease to a value much lower than the left-hand value, and the two horizontal channel measured capacitances once again stay unchanged. Section 9.c and channels 9.c.0 and 9.c.1 illustrate this in an exemplary manner. The above exemplary discussion for a horizontal rolling movement of the user's finger may also be conversely applied to the situation where the user's finger rolls in a vertical direction.

Due to the highly sensitive proprietary capacitance measurement technology available on the market, it may be possible to measure a sufficient change in projected capacitance due to finger rolling to allow accurate navigation of the complete 2D space displayed by the hosting mobile electronic terminal.

The disclosed invention may lend itself to implementation using only a single sided PCB material for the electrode pattern. Due to the simplicity of the electrode patterns, it may be possible to easily scale the CCTP module, for example from 5 mm by 5 mm to 20 mm by 20 mm, without significant design changes. These dimensions are given only as example, and not to place upper or lower dimensional limits on the disclosed invention. Indeed, it may be quite possible to realize capacitive track pads with dimensions well above 20 mm by 20 mm, using the simple minimal electrode pattern disclosed. Another advantage of the invention is that it may allow the realization of non-square track pads that can facilitate highly accurate 2D navigation of the complete space available on a mobile electronic terminal display. The art holds many projected capacitance structures that are non-square. However, all of these are used for single point actions, such as selection, or very limited navigation. It may also be possible to incorporate a large number of different electrode types and combinations within the scope of application of the disclosed invention, with good results.

FIG. 10 illustrates another aspect of the invention in an exemplary manner. To avoid ambiguities in measured data if the user's finger 10.1 moves beyond the boundaries of the group of vertical and horizontal electrodes, a guarding electrode 10.2 may be used. With the user's finger 10.1 over or within the space defined by the two groups of vertical and horizontal transmit and receiver electrodes, the capacitance between the guarding electrode 10.2 and any of the outer electrodes, for example a left-hand transmit electrode 10.3, should stay fairly constant with finger movement. However, should the user move his finger beyond the nominal space, as illustrated for example by FIG. 10, the capacitance between the guarding electrode and the outer electrodes of the nominal group should decrease rapidly. For example, in FIG. 10, the user's finger is situated close to the left-hand boundary. As such, it should couple electrically to the guarding electrode 10.2, with a resultant decrease in capacitance between the guarding electrode and left-hand vertical electrode 10.3, as illustrated in an exemplary manner by FIG. 10. Use of an additional electrode to detect the movement of the user finger beyond the nominal electrodes group boundary need not be constrained to the above example. It may be possible to use multiple boundary electrodes, of various shapes and sizes, and also combine these with nominal electrodes, for example vertical transmit and receiver electrodes 10.3 and 10.4, to improve nominal tracking of the user's finger movement.

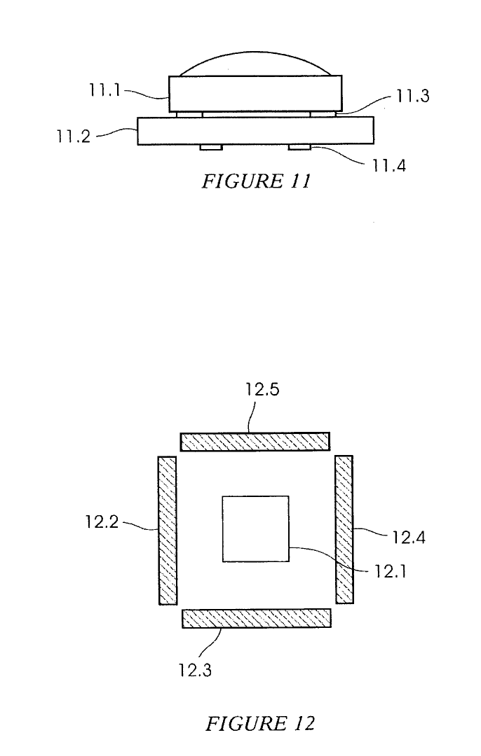

Although the disclosed invention's ability to use only a single layer of deposited electrodes provides a clear cost advantage, it need not be constrained to such a single layer embodiment. As illustrated by FIG. 11, in an exemplary manner, the various transmit and receiver electrodes may be deposited on two or more layers of, for example, a multi-layer PCB. In FIG. 11, for example, a dielectric covering 11.1 is on top of transmit electrodes 11.3, which have been deposited on the top side of a substrate 11.2. The corresponding receiver electrodes 11.4 are deposited on the bottom side of the substrate 11.2. This can be done, for example, to improve sensitivity, or for a range of other motivations. Further, the disclosed invention need not be limited to vertically stacked layers of electrodes, but also applies to electrodes arranged in multiple layers which may be dispersed in both vertical and horizontal directions.

The disclosed invention should also not be constrained to embodiments that have the minimal number of electrodes on the periphery of the CCTP. As FIG. 12 illustrates in an exemplary manner, the disclosed invention also includes, amongst others, embodiments where the transmitting or receiver electrodes, or both, are placed closer to the XY center of the CCTP. This embodiment might allow the use of an electrode 12.1 for both surface and projected capacitance measurements. In a first possible mode, it will be used to detect the proximity of the user's finger, using surface capacitance measurements. Once the capacitance of the electrode 12.1 to the surrounding electromagnetic environment increases beyond a predefined threshold value, the CCTP may switch over to a projected capacitance mode, where the capacitances between the transmit electrode 12.1 and receiver electrodes 12.2, 12.3, 12.4 and 12.5 are used to detect user finger movement with sufficient resolution to enable 2D navigation of the displayed space on the mobile electronic terminal.

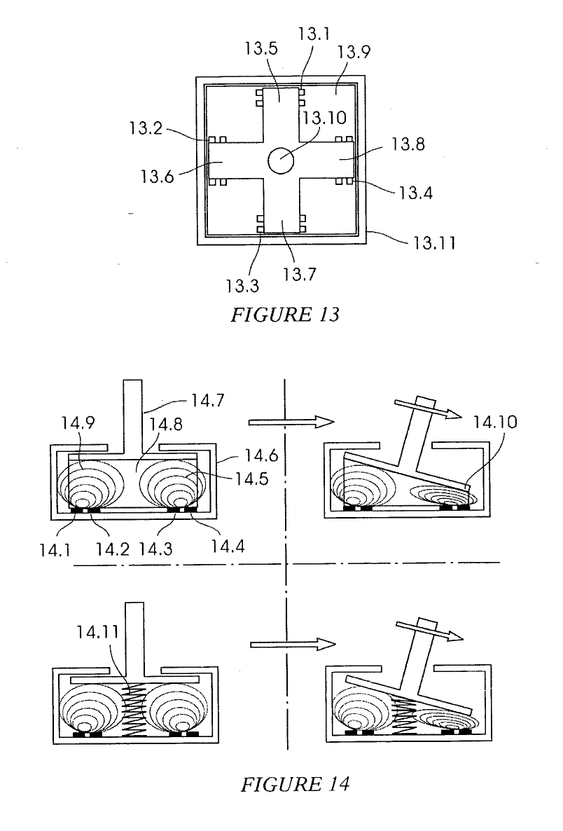

FIG. 13 shows a top view of a force dependent joystick based on a CCTP as taught in the preceding discourse, and as exemplary embodiment of the present invention. Electrode pairs 13.1, 13.2, 13.3 and 13.4 may be used to implement projected capacitance measurements. These electrode pairs may be overlaid with a vertical member 13.10, the “stick” of the joystick, and a dielectric or other plate, with orthogonal extremities 13.5, 13.6, 13.7 and 13.8, situated between the electrode pairs and the vertical member, and fully or in part supporting said vertical member. The plate and vertical member may be supported in turn by a compressible/flexible medium 13.9, and may or may not be enclosed by an enclosure 13.11. By tilting the vertical member in a particular direction, the plate, consisting of dielectric or other material may be brought closer to a particular electrode pair, thereby causing a measurable change in capacitance for said electrode pair. It should be appreciated that the plate below the vertical member does not have to be in the form of a cross as illustrated, but may be in any of a large number of geometrical forms, for example a square, rectangular, round etc.

FIG. 14 shows a side view of an exemplary CCTP based joystick implementation according the present invention. A vertical member and plate 14.7 is supported by a compressible/flexible material, such as, but not limited to, a low density rubber 14.8. Electrodes 14.1-14.4 are situated below the compressible/flexible material, and may be used to implement first and second projected capacitance electrode pairs. It should be appreciated that although the cross-sectional view of FIG. 14 only shows two electrode pairs, a typical implementation may also employ at least two other electrode pairs, orthogonal to those shown, or at another angle. Typical electric field patterns 14.5 and 14.9 for said first and second electrode pairs are illustrated. As the vertical member 14.7 is pushed to a particular side, the plate below it should tilt accordingly, as illustrated. This should result in the dielectric, or other, material of the plate being closer to the projected electrode pair underneath it, with a resultant decrease in measured capacitance, and for a charge transfer capacitance measurement technique, an increase in counts. A typical perturbation 14.10 of the electric field lines for an electrode pair is shown. The disclosed invention is not solely based on a reduction in measured capacitance due to tilting of the plate and vertical member 14.7, but includes the scenario where said tilting increases the measured capacitance.

FIG. 14 also illustrates a possible variation of the above joystick embodiment that utilizes a spring 14.11 to support the vertical member and plate, as opposed to a piece of compressible/flexible material 14.8 like low density rubber. In each case the elasticity of the material or spring should ensure that the vertical member returns to its original position upon release by the user. It may also allow the realization of a force dependent joystick, as a specific amount of force is required to push the vertical member and plate to a specific position against the reactive force of the compressible/flexible material or spring. Therefore, joysticks incorporating the teachings of the present invention should be able to sense not only the direction of movement required by the user, but also the rate or speed of movement.

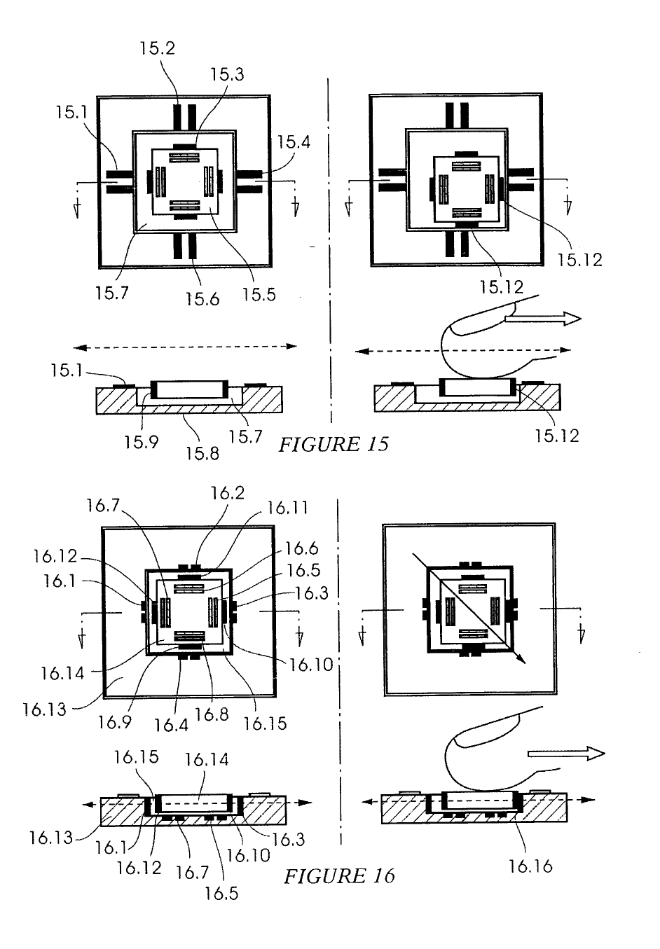

An improved CCTP according the present invention is shown in exemplary manner in FIG. 15. To overcome the potential drawback of not being able to sense 2D movement of a user's finger that equally covers all electrode pairs of the CCTP, and keeps covering them as the finger moves, the present invention teaches that a force dependent structure as presented in FIG. 15 may be used. A CCTP module 15.5, as taught during previous discourse of the present disclosure, is augmented by four additional projected capacitance electrode pairs 15.1, 15.2, 15.4 and 15.6. Further, the CCTP module 15.5 is contained within a compressible/flexible medium 15.7, and has conductive strips 15.3 and 15.9 on all four sides opposing the electrode pairs 15.1, 15.2, 15.4 and 15.6. A body 15.8 may or may not contain or support the whole above assembly. If a user's finger covers the electrode pairs of the CCTP module 15.5 in such a manner that he cannot navigate by moving his finger in a certain direction, as with nominal track pad operation, it is highly likely that the pressure exerted by the user on the CCTP module 15.5 will be increased, as the user becomes more agitated. The track pad surface is configured as part of the floating member 15.5 that is supported in the compressible/flexible medium held in the module body 15.8. Although the body 15.8 is shown as a well, it may be a compressible/flexible layer with the floating member positioned on top without vertical sides forming part of the body. Due to compressible/flexible medium 15.7, this increase in motional pressure should result in the CCTP module 15.5 moving towards one or two of the electrode pairs 15.1, 15.2, 15.4 and 15.6. Typically, this will result in one or two of the conductive strips contained on the side faces of the CCTP module 15.5 being closer to said electrode pairs (shown by 15.12) and in a decrease in the measured projected capacitance for the electrode pairs. In complement, one or two of the opposing conductive strips contained on the side faces of the CCTP module 15.5 should move further from one or two of said electrode pairs 15.1, 15.2, 15.4 and 15.6, resulting in an increase in the capacitances measured for these electrodes. These decreases/increases in measured capacitances of the electrode pairs 15.1, 15.2, 15.4 and 15.6, and the rate of change, may be used to navigate a 2D space, or to detect user agitation or another condition, and to react intelligently thereupon. It is envisaged, without placing a limit that the compressible/flexible medium will contract or expand very little, on the order of micrometers. However, with high sensitivity capacitance measurement solutions, as invented and as produced by the present Assignee, these motional changes should be sufficient to detect 2D navigation efforts of the user. In other words, to the user, the improved CCTP module, such as illustrated in FIG. 15, will ostensibly seem static in nature.

It should further be appreciated that the embodiment exemplified by FIG. 15 may also function with other capacitance measurement techniques, which may, for example result in an increase in measured capacitance as the module 15.5 is pressed closer to a particular side. The disclosed invention further also includes the possibility to interchange additional electrode pairs 15.1, 15.2, 15.4 and 15.4 with the opposing conductive strips 15.3 and 15.9 located on the sides of the floating member 15.5. That is, an embodiment may be realized where the additional electrode pairs are placed on the sides of the floating member 15.5, and conductive strips are placed on the static periphery opposing said electrode pairs. The conductive strips may be floating electrically, or placed at a dedicated static electrical potential.

FIG. 16 illustrates an alternative exemplary embodiment to that shown in FIG. 15. The additional capacitive sensing electrode pairs 16.1-16.4 are positioned on the body 16.13 and conductive strips 16.9-16.12 are positioned adjacent said additional electrode pairs, but on the floating member 16.14. In this manner, the electronics may be placed on the static body 16.13 and not on the floating member 16.14, alleviating the need for movable connections to the floating member. The track pad electrode pairs 16.5-16.8 must also be placed on the body 16.13 below the floating member 16.14 if connections from electronics to the floating member are to be avoided. As before, a compressible/flexible medium 16.15 is used to suspend and support the floating member 16.14. If a user increases his/her pressure in a specific direction, said compressible/flexible medium 16.15 will compress, resulting in a decrease in the distance between said conductive strips and said additional capacitive sensing electrode pairs on the one side, and an increase in said distance on the opposing side, with measurable changes in the associated relevant capacitances. An exemplary decrease in distance between a conductive strip on said floating member and an additional capacitive sensing electrode pair is shown at 16.16. It should be noted that in the embodiment presented by FIG. 16, the upper surface of the floating member 16.14 is used as the track pad surface for nominal functionality, with the movement of the user's finger sensed through said floating member via the electrode pairs 16.5-16.8, similar to that described during earlier discourse of the present disclosure. Said conductive strips may be floating electrically, or placed at a dedicated static electrical potential.

It must be noted that in both the joystick implementation and the track pad with directional pressure detection capability, the movement shown in the diagrams may be seen as exaggerated to better illustrate the concept. In fact the finest of deflections can be accurately measured and as such the stiffness against movement may be accommodated in the algorithms to reflect the desired movement of the cursor vs. movement of the floating member.

In the exemplary embodiments as shown in FIG. 15 and FIG. 16, the detection of the contact point (finger slide) is combined with the detection of pressure in a horizontal (2D) plane. This is especially helpful when a user inadvertently covers all the sense electrodes with a finger, hence defeating the detection of a moving point of contact over the CCTP surface. The latter is unfortunately the desired way to operate an Optical Track Pad (OTP) such as found in some Blackberry products (circa 2010). In this case the track pad will typically experience more force in a direction in the 2D plane and this force can be detected and translated in movement of, for example, a cursor on a screen.

Essentially the invention requires a construction wherein pressure towards a specific direction can be detected and this information is used to interpret or assist in interpreting the user action in terms of track pad functionality.

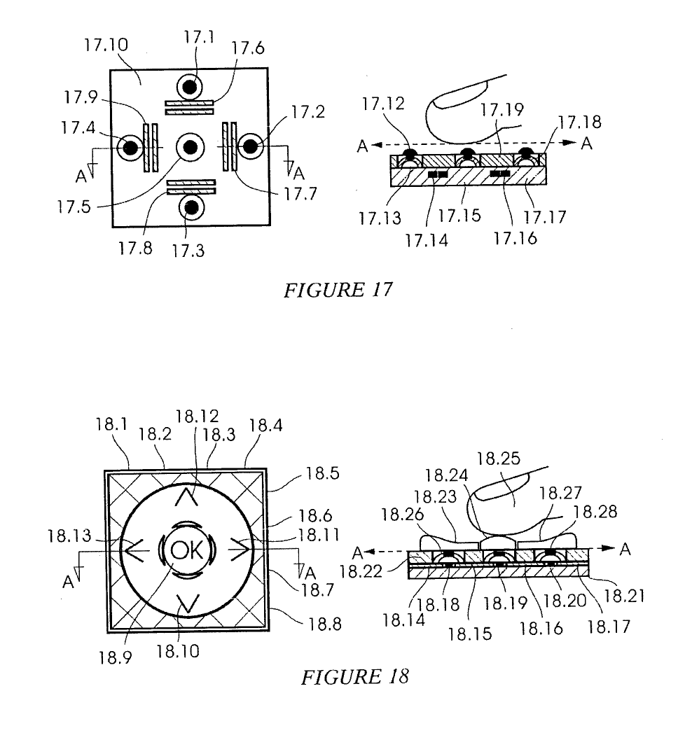

FIG. 17 illustrates an exemplary embodiment of the present invention that may find good application in products such as remote controllers for televisions, set-top boxes and satellite decoders, amongst others. A compact capacitive track pad, as disclosed by the preceding discourse, is realized within a rigid substrate 17.17. Electrode pairs 17.6, 17.7, 17.8 and 17.9, are used for projected capacitance measurements to track the movement of a user's finger, as explained earlier. This may be used to provide the user with the ability to navigate menus or 2D spaces presented by the product for which the remote control is used. Cross-sectional view AA′ shows typical relative positions of said electrode pairs, in this case represented by 17.14 and 17.16. To enable dedicated selection functions with tactile feedback, as users have become accustomed to experience, domed switching structures 17.1, 17.2, 17.3, 17.4 and 17.5 are positioned above the compact capacitive track pad sense electrode layer. In the exemplary embodiment shown, said domed switches are used to make/break galvanic connections in a circuit to indicate selections. As shown in cross-sectional view AA′, a ring electrode 17.13, lies underneath a dome electrode 17.18. A protruding member 17.12, may be used to help the user locate the relative position of a selection switch, and also improve the ease with which said dome is depressed. If the user applies sufficient downward force onto the protruding member 17.12, and thereby on the dome underneath, said dome will typically give a tactile click, and deflect rapidly, resulting in it being electrically connected to the underlying ring. To improve capacitive coupling between the user's finger and the track pad underneath the five exemplary switching structures, said dome switch structures are contained within a compressible/flexible material 17.19 that is a better dielectric than air. An opening exists in the compressible/flexible material around each dome, as shown in the cross-sectional view, to reduce hindrance to mechanical movement of said dome and the accompanying protruding member as far as possible.

In another embodiment as a variation on FIG. 17, the dome structures may be placed over the sensing electrode pairs 17.6, 17.7, 17.8 and 17.9, with the depression of a specific dome being detected capacitively, without or without requiring electrical contact.

The presently disclosed invention also allows for the realization of switching structures that use capacitive measurements to discern a switching action, using the methods disclosed in PCT/ZA2011/000021, filed by the present inventor, and which is incorporated in its entirety into the present disclosure. FIG. 18 illustrates an exemplary embodiment. An array of orthogonal electrodes are realized, ostensibly using diamond shapes. In the example shown, electrodes 18.1 to 18.4 form the vertical electrodes, and electrodes 18.5 to 18.8 the horizontal electrodes. The drawing on the left in FIG. 18 represents, for example, control buttons which are located at a control location on a remote control device used to operate a television set (the remainder of the device is not shown).

By using projected or mutual capacitance measurements, between various combinations of vertical and horizontal electrodes, the position and movement of an engaging probe, for instance a user's finger(s), on the track pad may be discerned, as is well known in the art of capacitive sensing. As is shown, a thin piece of track or otherwise conductive material is typically used to connect the diamond shapes of a given electrode together. Said pieces of track or otherwise conductive material of vertical and horizontal electrodes cross each other at intervals, necessarily without making electrical contact, for example by using vias and more than one layer of conductive material. By nature of the projected capacitance measurements used for such track pads, the most sensitive spots are located where four diamond points are juxtaposed. Therefore, as is known in the art, the resolution of the track pad may typically be improved by increasing the number of vertical and horizontal electrodes per area.

However, one of the drawbacks of track pads is the lack of tactile feedback given to a user, especially during selection actions. According to the present invention, this can be overcome without the need for electrical make/break switches. As shown in the exemplary embodiment of FIG. 18, by placing a conductive dome like structure 18.26, above the junction of four diamond points, a tactile switch based on capacitive measurements as disclosed in PCT/ZA2011/000021 may be realized. If sufficient pressure is applied to said dome structure, it will deflect downwards suddenly, given the user the well-known tactile “click” that users have become accustomed to. This should result in the conductive material of the dome suddenly being very close to four diamond electrodes that form the junction, and a resultant significant change in measured capacitance. According to the present invention, such a sudden change in measured capacitance for a specific point on the track pad may be used to discern a selection action by the user, while giving the user satisfactory tactile feedback.

Naturally, an embodiment as disclosed above, and presented by the example of FIG. 18, may be used to provide a user with 2D navigation abilities and dedicated selection functionality that provide satisfactory tactile feedback. In the example of FIG. 18, an overlay structure 18.23, 18.24 and 18.27, is placed over five conductive dome-like structures 18.9, 18.10, 18.11, 18.12 and 18.13. Said overlay structure typically forms the top part of the buttons that a user needs to depress to perform a specific selection, for example on a television screen, and as such, may be marked in accordance, as shown. Underneath said top overlay may be a small rigid or semi-rigid shaft 18.28. This shaft may serve to focus the downward pressure of the user's finger 18.25 onto the centre of dome structure. As discussed before, the dome-like structures are typically placed over specific junctions of vertical and horizontal electrodes 18.18, 18.19, and 18.20, and 18.14, 18.15, 18.16 and 18.17 respectively, shown in cross-section AA′. To improve capacitive coupling between a user's finger 18.25 and the track pad electrodes when used for 2D navigation, a compressible/flexible material 18.22 is inserted between the top overlay and the track pad electrodes, as shown. Once again, to decrease hindrance to mechanical movement of the dome structures as far as possible, openings may exist in the compressible/flexible material immediately surrounding each dome.

In the exemplary embodiment of FIG. 18, the dome structures need not necessarily be conductive. Use of non-conductive dome-like structures, but with a conductive disk or pill attached to the highest point on the inner side of the dome, is also claimed by the presently disclosed invention. When a user places sufficient downward pressure onto said non-conductive dome, the dome should deflect and snap suddenly, resulting in said conductive disk or pill rapidly being placed much closer to the junction of electrodes underneath, with a resultant abrupt change in measured capacitance.

1-26. (canceled)

27. A capacitive 2D track pad module wherein only four projected capacitive sensing electrode pairs are used to determine any parameter from the group comprising speed, direction and distance, of a user touch gesture on an outer 2D track pad surface, and that allows indirect user navigation in a displayed 2D space on a display terminal wherein the module also includes secondary projected capacitive sensing electrode pairs, and a floating member, that forms said outer 2D track pad surface, with conductive areas positioned proximate the secondary electrode pairs, wherein movement of the floating member as a result of force exerted by a user on the floating member in the 2D plane, causes said conductive areas to change position relative to said secondary electrodes, resulting in a corresponding change in measured capacitance for said secondary electrodes and wherein the measured change in capacitance is translated into a metric that influences tracking movement in the 2D plane.

28. The capacitive 2D track pad module of claim 27 with dimensions less than 2 cm×2 cm for use in a mobile phone or e-reader.

29. The capacitive 2D track pad module of claim 27 wherein projected capacitance measurements are made using two drive electrodes and two receiver electrodes.

30. The capacitive 2D track pad module of claim 27 wherein a correlation of the metric indicating the variation in strength of touch is used in combination with a limited measurement in movement and time to determine a tap or a double tap gesture.

31. The capacitive 2D track pad module of claim 27 wherein an additional channel and plurality of electrodes are used to detect when a user's finger, or other engaging probe, is moving outside a nominal area used for movement and touch sensing.

32. The capacitive 2D track pad module of claim 27 wherein a metric for proximity is used to determine an approximate height of a user's finger, or other engaging probe, above a track pad structure, thus adding a 3rd dimension to navigational data supplied to a hosting processor.

33. The capacitive 2D track pad module of claim 27 wherein rolling motion and sliding movement of a user's finger on the outer 2D track pad surface are used to direct or control a cursor movement.

34. The capacitive 2D track pad module of claim 27 wherein the speed of movement detected is used to adjust the translation of distance and speed of movement on a display of a cursor associated with the track pad.

35. The capacitive 2D track pad module of claim 27 wherein the electrodes are covered by a plastics which is substantially impermeable to visible or infrared light.

36. The capacitive 2D track pad module of claim 27, where the conductive areas are either electrically floating or grounded.

37. The capacitive 2D track pad module of claim 27, with a plurality of tactile dome switch structures, wherein depression of a dome switch structure is capacitively determined, and used to indicate specific selections when depressed.

38. The capacitive 2D track pad module of claim 27, with the addition of a plurality of tactile dome switches, and wherein said switches are used to make or break electrical connections to indicate specific selections, with the addition of compressible material situated between a user's finger and the track pad, to improve capacitive coupling, and with absence of compressible material in the immediate vicinity of said dome structures.

39. A capacitive measurement system as part of a structure forming a selection button or key in a user interface, with a size that fits within 5 mm by 5 mm, said button structure comprising an underlying dome switch structure that is used to detect a user touch with sufficient pressure to activate or snap said dome switch structure, wherein said system utilizes two electrode structures per primary direction to recognize in which direction a user's finger, or other engaging probe, slides while interfacing with a product via said button structure, said primary direction defined as one of two orthogonal directions in a 2D plane.

40. The capacitive measurement system of claim 39 wherein proximity and/or touch events are used to provide information to a user with regards to said button, and wherein a touch event with at least a minimum pressure applied through the touch results in rapid deflection of said dome switch structure, said deflection being detected and interpreted as a selection gesture.

41. The capacitive measurement system of claim 39 wherein said dome switch structure is used to give a tactile feel, but without the making/breaking of electrical contact when pressed to rapidly deflect or snap.

42. The capacitive measurement system of claim 41, wherein activation of said dome switch structure and the capacitive measurement detection thereof are used to indicate an event that is equivalent to a specific button selection to a hosting processor or product.

43. The capacitive measurement system of claim 42 wherein the proximity and/or touch detection information is used to implement a 2D track pad that is integrated in a key pad or a key board of a remote control, mobile phone device, laptop computer, tablet computer or an e-Reader.

44. A 2D capacitive track pad that includes a plurality of sensing electrode structures and conductive dome structures placed over said electrode structures, said dome structures being electrically insulated from one another, wherein sufficient pressure on an overlay above the dome structures results in a snap or rapid deflection of a specific dome structure, providing a user with tactile feedback, and resulting in a sudden measured change in capacitance for a specific electrode structure that is opposite to a measured change in capacitance measured for a touch event or a proximity event on the same electrode structure, wherein said overlay marks relative positions of said dome structures, and with openings or compressibility/flexibility in said overlay in the immediate vicinity of said dome structures, to allow for movement of the dome structures.

45. The 2D capacitive track pad of claim 44, wherein a user navigates an associated 2D space by moving his/her finger over the overlay in an unconstrained manner using proximity or touch gestures, and wherein detection of said snap or rapid deflection of a specific dome structure is used to discern a user selection action equivalent to a button activation, and wherein an icon or a cursor is shown differently according to whether a proximity event (no physical contact), touch event (physical contact) or touch event with more than a minimum pressure is detected.
